(19) United States
(12) Patent Application Publication
(10) Pub. No.: US 2007/0129860 A1
(43) Pub. Date: Jun. 7, 2007

(54) Vehicle Service Equipment Interface Drivers

(75) Inventor: David A. Voeller, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: HUNTER ENGINEERING COMPANY, Bridgeton, MO (US)

(21) Appl. No.: 11/567,495

(22) Filed: Dec. 6, 2006

Related U.S. Application Data
(60) Provisional application No. 60/742,714, filed on Dec. 6, 2005.

(51) Int. Cl. G01M 17/00

(52) U.S. Cl. 701/29

(57) ABSTRACT

A vehicle service system including a processing system configured with at least one customized software driver and a supporting binary to facilitate interaction with, and control of, the various software applications and hardware devices associated with the vehicle service system.

### CROSS-REFERENCE TO RELATED APPLICATIONS

The present application is a non-provisional application of U.S. Provisional Patent Application Ser. No. 60/742,714 filed on Dec. 6, 2005, from which priority is claimed, and which is herein incorporated by reference.

### STATEMENT REGARDING FEDERALLY SPONSORED RESEARCH

Not Applicable.

### BACKGROUND OF THE INVENTION

The present invention is related generally to vehicle service systems, and in particular, to the software driver objects with which a processor, associated with a vehicle service system such as a wheel alignment measurement system, is configured for facilitating interaction between various hardware components of the vehicle service system.

It is common for vehicle service equipment manufacturers to use a personal computer (PC) running a graphical user interface (GUI) operating system (OS), such as a variety of Linux or Microsoft Windows operating systems, as the system processor in a vehicle service system such as a vehicle wheel alignment measurement system. In order for the system processor to gather information from an external measuring/sensing device, the system processor is configured with one or more vehicle service software applications and one or more specialized software binaries, commonly known as drivers.

A software driver is a software program that interacts with a particular hardware device or other software program such as another driver to provide an operating system with specific information necessary to interact with the hardware device or software program. The software driver is configured to enable interaction between the interfaces to the hardware device and the vehicle service software applications, and is often packaged as a Dynamic Link Library (DLL) file with the file extension of “.sys”. In a vehicle wheel alignment system, software drivers may be responsible for communicating with a variety of hardware devices, including, but are not limited to, any of the following: Ethernet devices, ISA devices, PCI devices, PCI Express devices, Firewire hardware, serial ports, parallel ports, WiFi devices, Bluetooth devices, Zigbee devices, and USB hardware. In each case, a software driver is used to interface between the device and the software applications residing on the vehicle service system processor.

Software drivers are essentially a required component within an operating system and are often complex programs which are difficult to diagnose and repair in the event of a fault. For some driver complexities, there are solutions offered by third-party software manufacturers other than the developers of the operating system, but using those solutions introduces several other problems. For example, third party driver solutions may not stay current with the latest operating system changes and technologies, causing either error conditions for the vehicle service system due to operating system modifications not done by the OEM of the vehicle service system, or creating non-deployable vehicle service software on different operating systems. Another problem which can arise is the increased difficulty of isolating a software driver problem when it occurs, because the problem may be in the software driver source code, the third party solution, or in the operating system. If the problem is in the third party solution it means there is the added difficulty in understanding how that third party solution works, over and above understanding the interrelationship of the software driver source code with the operating system.

An additional problem with using third-party provided solutions to solve software driver problems arises when a fault occurs that cannot be solved by any technical support provided by the third-party. Most of the technical support available for drivers is available only for the operating system developer's product, and not for any third-party provided solutions. More times than not, a software driver developer is required to network with other driver developers, contact an operating system developer, or search the World Wide Web for answers to questions or solutions to problems associated with their software driver. This is a common problem for complex devices such as vehicle service systems because these systems typically need to gather measurements from numerous hardware devices and sensors which are external to the processing system, and which require specialized drivers to interact with the system processor.

Driver architectures can be extremely complex. For example, the current Microsoft Windows Driver Model (WDM) utilized to communicate with a Microsoft Windows operating system requires thousands of lines of driver code for communicating with the operating system and supporting requirements of the WDM. The software code is therefore very complicated and may vary between different operating systems. Furthermore, not all of the software code required by a driver architecture is necessarily utilized to establish the interface between a hardware component and the operational software of the PC, leading to the development of drivers which contain large portions of unused software code. For example, in software drivers developed by Hunter Engineering Co. for use with machine-vision vehicle wheel alignment sensors, only a small portion of the WDM requirements is actually utilized for the purpose of communicating with the machine-vision vehicle wheel alignment sensors.

An example of a complicated software driver currently utilized in many vehicle service systems is a Universal Serial Bus (USB) driver associated with the Microsoft Windows XP Operating System. The USB drivers are required to conform to the Microsoft Windows Driver Model (WDM) specifications and must support hardware that attaches and detaches from the processing system, referred to as a Plug and Play (PnP) event. The WDM standard further requires a driver to support Power Management, which refers to the capability of the hardware attached to the processing system to enter into a variety of powered up or down states depending on a variety of factors, e.g., when the hardware powers down due to lack of use for a specified amount of time. These states may include a fully powered state, a low performance state, a standby state, a sleep state, and an off state.

The PnP and Power Management requirements of the WDM standard are extremely complicated to support in a software driver, often requiring thousands of lines of code, and are almost never correctly implemented. The PnP support is necessary in vehicle service equipment because it is a common practice for a technician to attach and detach hardware, such as sensors, from the vehicle service system during use in a shop environment. Similarly, Power Management support is increasingly important in regions where power is a scarce resource and where customers are very sensitive to service equipment that uses power inefficiently.

The skills and knowledge necessary to build software drivers differ significantly from the skills and knowledge required to develop software applications such as vehicle wheel alignment applications. Because drivers typically run in kernel mode, software drivers have memory access restrictions, such as when accessing pageable memory. If a driver running in kernel mode makes a memory mistake such as accessing pageable memory that failed to be translated from a kernel virtual address to a physical address, a PAGE_FAULT_IN_NONPAGED_AREA error will likely occur. Similarly, a driver developer has to be aware of what interrupt request level (typically referred to as IRQL) the driver software is running in, because if the IRQL is too high and the driver code is executed anyway, another error condition is likely to occur. A programmer skilled in the design and development of software drivers and hardware interfaces will generally not be skilled in the high-level programming languages used in vehicle service applications, and will not have the specific knowledge necessary to understand or appreciate the specific interface needs of vehicle service applications. Rather, a programmer skilled in the design and development of software drivers and hardware interfaces focuses on the specific interaction between hardware components and the wide variety of systems to which that hardware component might be connected.

Accordingly, it would be advantageous to provide a vehicle service system, such as a vehicle wheel alignment system, with improved software drivers for facilitating interactions between the vehicle service system processor and various hardware devices and vehicle service software applications which comprise the vehicle service system.

In addition to providing an improved software driver, it would be advantageous to provide a vehicle service system such as a vehicle wheel alignment system with improved diagnostic functionality for tracing and diagnosing faults in software drivers associated with the system processor to improve vehicle service system speed and reliability.

### BRIEF SUMMARY OF THE INVENTION

Briefly stated, in one embodiment the present invention provides a vehicle service system, such as a vehicle wheel alignment system, with an improved software driver for facilitating interaction between the vehicle service system processor and one or more components such as hardware devices and other software binaries which comprise the vehicle service system. Software binaries are machine code loadable into memory from storage that can take several forms, including Dynamic Link Libraries files with the .dll extension, driver files with the .sys extension, and executable files with the .exe extension. The improved software driver eliminates unnecessary source code, and facilitates the diagnosis and correction of software driver faults which may occur during operation of the vehicle service system.

In an alternate embodiment, the present invention provides a vehicle service system, such as a vehicle wheel alignment system, with at least one vehicle service system driver developed to make use of a support binary which implements at least one of the following: Plug-and-Play (PnP) handling, Power Management handling, synchronization or I/O queuing. The support binary provides one or more Device Driver Interfaces (DDIs) which the vehicle service system driver can utilize as necessary to customize the handling of PnP, Power Management, synchronization, and/or I/O queuing events.

An alternate embodiment of the present invention provides a vehicle service system, such as a vehicle wheel alignment system, with at least one vehicle service system driver developed and designed to run in a user process mode. The vehicle service system driver utilizes a support binary which is configured with Device Driver Interfaces (DDIs) to enable the vehicle service system driver to customize the functionality provided by the support binary as may be necessary.

An alternate embodiment of the present invention provides a vehicle service system, such as a vehicle wheel alignment system, with a processing system configured to provide information about software objects to software applications which are responsible for managing other software objects. The processing system is further configured with extensions to software drivers for capturing instrumentation data and events from device drivers and kernel components, enabling the generation of secure event files for remote analysis without interference with executing user applications.

In an alternate embodiment of the present invention, a vehicle service system, such as a vehicle wheel alignment system, is configured with a processing system implementing advanced operation tracing implementations, such as Windows Management Instrumentation (WMI) tracing, Windows Preprocessor (WPP) tracing, and/or Event Tracing for Windows (ETW) tracing.

An alternate embodiment of the present invention provides a vehicle service system, such as a vehicle wheel alignment system, with a processing system configured to support Online Crash Analysis (OCA). The processing system is configured to connect to a communications network to communicate an event report to a remote system in the event a system error occurs during operation of the vehicle service system, enabling the remote system to receive and analyze the event report, and to provide a software solution for subsequent installation at the vehicle service system.

The foregoing features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a block diagram illustrating prior art I/O flow to a kernel-mode WDF driver;

FIG. 2 is a block diagram illustrating prior art user-mode WDF driver architecture;

FIG. 3 is a block diagram illustrating prior art I/O flow to a user-mode WDF driver;

FIG. 4 is a block diagram illustrating a prior art device driver configuration;

FIG. 5 is a block diagram illustration of a device driver configuration of the present invention;

FIG. 6 is a block diagram illustration of a vehicle service system device driver configuration of the present invention; and

FIG. 7 is a block diagram illustration of an alternate vehicle service system device driver configuration of the present invention.

Corresponding reference numerals indicate corresponding parts throughout the several figures of the drawings. It is to be understood that the drawings are for illustrating the concepts of the invention and are not to scale.

### DESCRIPTION OF THE PREFERRED EMBODIMENT

The following detailed description illustrates the invention by way of example and not by way of limitation. The description enables one skilled in the art to make and use the invention, and describes several embodiments, adaptations, variations, alternatives, and uses of the invention, including what is presently believed to be the best mode of carrying out the invention.

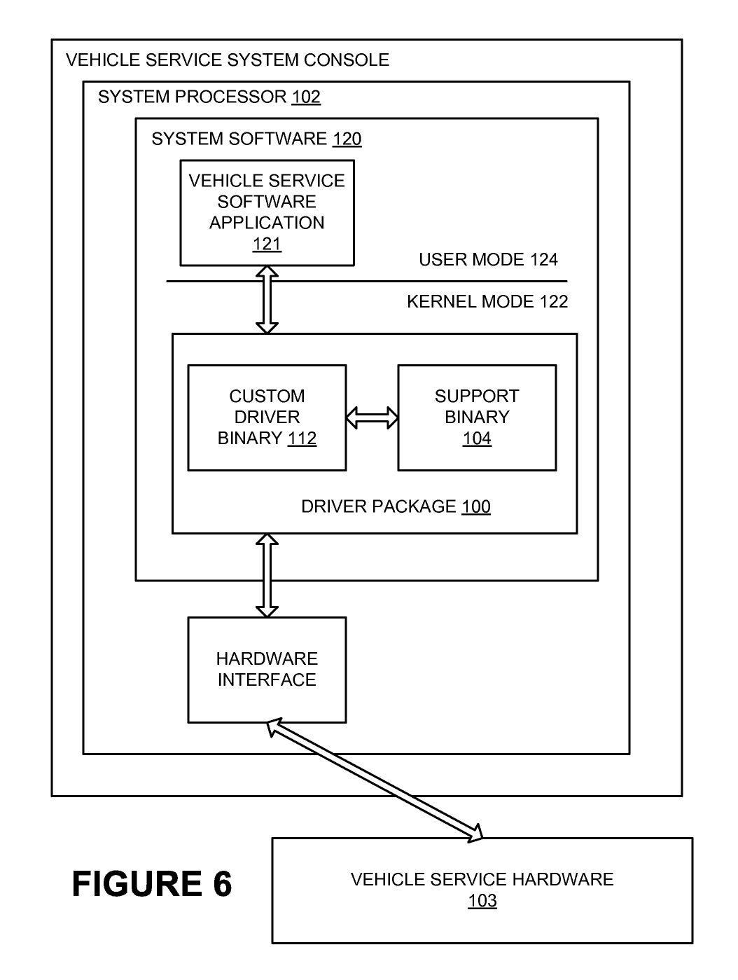

Turning to FIGS. 5 and 6, the present invention provides a vehicle service system, such as a vehicle wheel alignment system, with a software driver package 100 for facilitating interaction between a vehicle service system processor 102 and various hardware devices 103 and software applications which comprise the vehicle service system. The software driver package 100 separates generic support source code 104, such as that associated with PnP 106, input/output control (I/O) 108, and Power Management 110 from a customized driver 112 when such features are not required for operation of the specific component of the vehicle service system associated with the customized driver 112. Separation of the generic support source code 104 from the customized driver 112 facilitates the diagnosis and correction of faults in the customized driver 112 operating on the vehicle service system by limiting the customized driver 112 to device-specific handling instructions 114.

Preferably, within the software driver package 100, customized software drivers 112 interact with generic supporting binaries 104 as shown in FIG. 5 to provide services. In effect, the support binaries 104 shield the customized software drivers 112 from the specific details of the driver requirements for features such as PnP 106 and Power Management 110 which might be needed for the operating system but are not needed by the software drivers 112 to support the intended hardware. The supporting binaries 104 receive I/O requests and call the customized software drivers 112 as needed to handle events according to each software driver's configurations, or apply default handling. The supporting software binaries 104 provide intelligent handling for common operations such as PnP 106 and Power Management 110 so that customized software drivers 112 do not require large amounts of “boilerplate” source code which is directed towards features or actions that are unnecessary for the specific software driver operation, or for the operation of the vehicle service system.

The supporting software binaries 104 provide support for common features required for most customized software drivers, and permit device-class-specific extensions that can be added. As new features are added to an operating system 120 of the vehicle service system, and as new software driver classes are supported, such as new vehicle wheel alignment sensor units, features that are common to all of the device classes can be added to a base set of support binaries 104. Extensions to the support binaries 104 provide features that are required by one or more specific device classes, but not by every device class.

In one embodiment of the present invention, a vehicle service system utilizes drivers which are implemented using a commercially available driver model known in the industry as the Windows Driver Foundation (WDF). A detailed description of the architecture of the WDF can be found in the Microsoft Whitepaper “Architecture of the Windows Driver Foundation”, dated Sep. 30, 2005 and herein incorporated by reference. In a graphical user interface operating system, such as those found in many vehicle service system processors, the WDF support is packaged as a co-installer dynamic link library (DLL) that is loaded into the processing system from a data storage. The WDF technology improves upon many aspects of software driver development such as by improving the handling of PnP and Power Management issues.

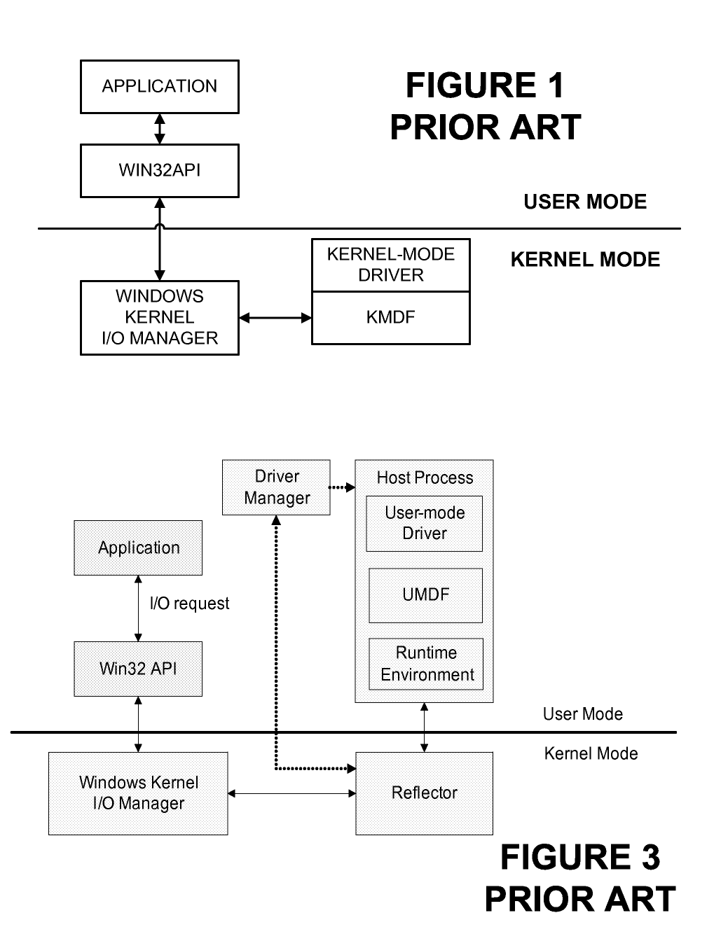

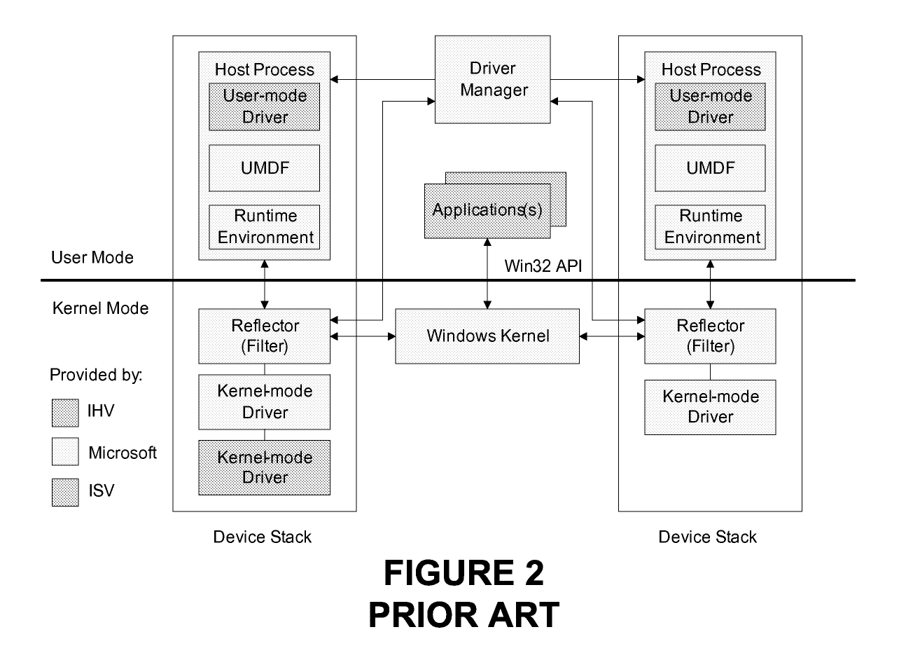

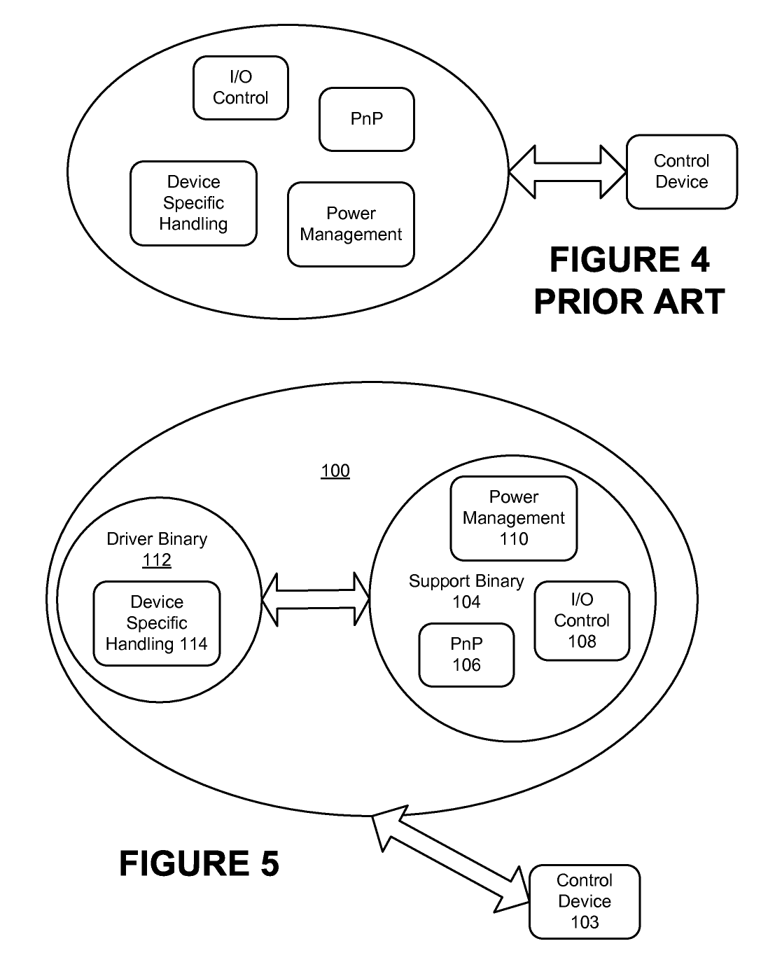

As part of the WDF architecture, a Kernel Mode Driver Framework (KMDF) shown in FIG. 1, and a User Mode Driver Framework (UMDF) shown in FIG. 2, are provided. These WDF driver frameworks provide the basic driver support in the form of a support binary 104, and performs the following services for WDF-compliant customized software drivers 112:
Defines WDF objects that the customized software drivers 112 can instantiate;
Manages object lifetimes;
Exposes a basic set of DDIs that the customized software drivers 112 may utilize to manipulate the objects;
Provides a support binary 104 with common implementation of features that the customized software drivers 112 typically require, such as Plug and Play, Power Management, synchronization, I/O queues, and access to the registry; and
Manages the flow of I/O requests and Plug and Play and power notifications from the operating system 120 to the customized software drivers 112.

Instead of calling the vehicle service system operating system 120 directly for every interaction, customized software drivers 112 conforming to the WDF model can interact with the appropriate supporting elements as shown in FIG. 1 and FIG. 2 for supported services. In effect, the WDF model shields the customized software driver 112 from the specific details of interacting with the operating system 120 for supported services.

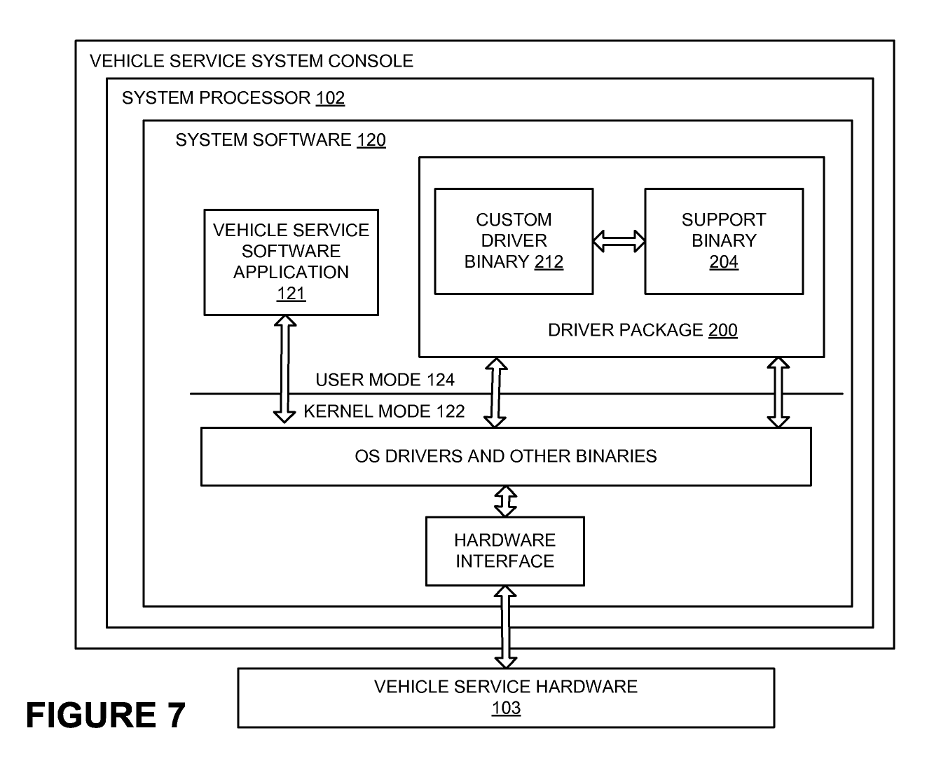

In an embodiment of the present invention, a kernel mode driver model shown in FIG. 6, and a user mode driver model shown in FIG. 7 are utilized in a vehicle service system to implement I/O queues, Plug and Play support and Power Management support. Both the kernel mode driver model and user mode driver model can be implemented using the KMDF and UMDF respectively. Each support binary in the driver package receives I/O requests, calls the vehicle service system customized software drivers 112 to handle events according to the customized driver's configurations, and applies default handling otherwise. Both the KMDF and UMDF provide intelligent default handling for common operations, so that customized software drivers 112 do not require large amounts of “boilerplate” code which is directed towards features or actions that are unnecessary for the specific driver operation.

The KMDF and UMDF support common features required for software driver device classes. Device-class-specific extensions can also be added. For example, a KMDF implementation of FIG. 6 supports extensions specifically for USB devices. As new features are added to a vehicle service system operating system 120, and as new software driver device classes are supported, features that are common to all device classes are added to the base set of DDIs in the frameworks. Extensions to the frameworks provide features that are required by one or more specific device classes, but not by every device class.

For example, machine vision vehicle wheel alignment sensor drivers and wheel alignment systems utilizing USB Interface Board drivers may be reconfigured using a software package 100 where a customized software driver 112 conforms to the WDF technology, enabling the PnP and Power Management to be fully handled by the support binary 104 which in this case would be a KMDF, unless the sensor driver 112 is specifically configured to handle some parts of PnP and Power Management.

There are several different configurations for customized software drivers 112 of the present invention which are improvements over existing vehicle service equipment software drivers. In one embodiment of the present invention, software drivers 112 in a vehicle service system are implemented in the kernel mode 122 of the operating system 120 using a Kernel Mode Driver Framework (KMDF). KMDF drivers are like most software drivers in that they run in kernel mode 122. This means that if an error occurs during operation of the driver package 100 such as accessing memory pages that have been paged out and are no longer accessible, an error check procedure is likely to be triggered. However, the KMDF creates a more reliable driver package 100 because the support binary 104 is a more tested and therefore hardened piece of software and the customized driver 112 has less code that can create an error condition.

A KMDF custom software driver 112 interacts with WDF objects in a support binary 104 through a Device Driver Interface (DDI) which is a software object having properties, methods and events. A property describes the characteristics of the object, and is associated with methods that retrieve and set the value of the property. A method performs actions on the objects, and an event is a condition for which a driver might need to take an action.

For kernel-mode 122 drivers, the KMDF shown in FIG. 1 does not replace the older driver models such as the WDM. Instead, it provides a skeletal WDM implementation for the software driver. In effect, a custom software driver 112 is configured to work with a particular hardware device 103 by creating objects and providing event-based callback routines. The custom software driver 112 can still interact with the operating system as it did before a support binary 104 was provided.

The KMDF provides a reentrant library or support binary 104 that can be shared by multiple customized software drivers 112. Each customized software driver 112 is dynamically bound with the library or support binary 104 at load time, and multiple versions of the library or support binary 104 can be used by multiple customized software drivers 112 simultaneously.

The KMDF currently supports creation of the following types of kernel-mode drivers:
Function drivers for Plug and Play control devices.
Filter drivers for Plug and Play control devices.
Bus drivers for Plug and Play control device stacks.
Control device drivers for legacy control devices that are not part of a Plug and Play stack.

WDF provides certain methods and callbacks specifically for bus drivers, others specifically for function and filter drivers, and still others for control device drivers.

The KMDF support binary 104 identifies a function driver, control device driver, or a bus driver based on the methods that a customized software driver 112 calls, and the callbacks that the customized software driver 112 supports. For example, the bus driver for a device typically supports callbacks to enumerate the children of the device 103 and to supply a list of the hardware resources that the device 103 requires. A function driver for a device typically supports callbacks to manage power to its device.

A filter driver explicitly identifies itself as such before creating its device object. The KMDF support binary 104 uses this information when passing I/O requests to the customized software driver 112. A filter driver registers for only the I/O requests it chooses to filter; the KMDF support binary 104 passes all other requests to the next lower driver in the driver stack of the operating system 120. (For a function or bus driver, WDF fails other requests.) By contrast, a WDM filter driver (custom driver 112 equivalent with no support binary 104) must accept all I/O requests that could be targeted to its device, pass those it does not filter to a lower driver, and act on the remaining subset. A WDM filter driver requires logic to inspect and forward many types of requests; a KMDF filter driver 112 has no such code because it receives only the requests it is interested in while the KMDF support binary 104 handles all other requests. In a vehicle wheel alignment application, filter drivers may be useful for filtering network driver data to locate camera image data, or for filtering RFID data received from a vehicle or vehicle component.

When a vehicle service software application 121 sends an I/O request to a kernel mode driver shown in FIG. 6 where the support binary 104 is implemented using KMDF, the request travels through the components shown in FIG. 1. As the figure shows, the following components are involved in handling an I/O request to a kernel-mode driver where the driver is built for the WDF model:
Application. The application is a user-mode process that issues I/O requests through the Microsoft Win32® API.
Win32 API. In response to the application's I/O request, the Win32 API calls I/O routines in the Windows kernel.
Windows kernel. The I/O manager in the Windows kernel creates an Interrupt Request Packet (IRP) to represent the request and presents it to the target driver by calling the driver at a designated entry point. For kernel-mode WDF drivers, the KMDF registers the entry points, in effect intercepting the request on behalf of the driver. For drivers built using a different driver model such as WDM, the entry points are made known to the Windows kernel in a different way.
KMDF. The KMDF processes the request by creating a WDF request object and calling the driver's event callback routines as required.

A vehicle wheel alignment system including a processing system configured with system software 120 and KMDF software drivers operates faster and more reliably than a similar system configured with conventional WDM software drivers when implementing PnP, Power Management, I/O queuing and synchronization.

In an alternate embodiment of the present invention, shown generally in FIG. 7, customized software drivers 212 in a vehicle service system are implemented in a user mode process. Implementation of a driver 212 in a user mode process has the advantage of not crashing the system software 120 when an error condition is generated. When the system software or operating system 120 crashes, vehicle service time is lost waiting for the operating system to reboot and reinitialize all of the system's hardware devices, services, and software objects before resuming the vehicle service procedures. A complete reboot of a crashed operating system may require a significant amount of time. By implementing a vehicle service system driver 212 in a user mode process, error conditions which might previously have triggered an operating system crash are now handled as when a software application crashes, which can be resolved and responded to in significantly less time, typically merely the amount of time required to restart the software application.

One method for creating a driver package for use in a user mode process as shown in FIG. 7, is to create the software driver 212 with support binary 204 using a User Mode Driver Framework (UMDF) such as shown in FIG. 3. Software, such as binaries or drivers 212, that run in user mode do so within their own virtual address spaces, and are restricted from gaining direct access to many parts of the processing system, including system hardware, memory not allocated for user mode, and other portions of the processing system that might compromise system integrity resulting in an error check. Software, such as binaries or drivers 212, that run in user mode as a user mode process are effectively isolated from kernel-mode processes and other user-mode processes. A detailed description of the design and implementation of UMDF software drivers can be found in Microsoft White Paper entitled “Introduction to the WDF User-Mode Driver Framework”, dated Jun. 2, 2005 and herein incorporated by reference.

An advantage of running a software driver 212 in user mode is that if a mistake is made, an exception or fault that may disable the entire operating system of the vehicle service system does not usually occur. UMDF software drivers 212 share the same model as KMDF software drivers 112, but the DDIs are not necessarily the same. A vehicle service system, such as a wheel aligner, having a processing system configured with UMDF software drivers 212 is unlikely to trigger an operating system fault check procedure upon the occurrence of an error, yet will still correctly implement PnP and Power Management concepts. Similarly, using UMDF software drivers 212 provides the benefit of being in user mode, allowing the opportunity to more easily design, create, deploy, maintain and fix the software drivers 212, therefore reducing costs.

The UMDF illustrated in FIG. 3 implements a subset of the KMDF functionality, including support for Plug and Play, Power Management, and asynchronous I/O. Software drivers 212 that run in user mode have access only to the user address space and therefore pose low risk to system stability. User-mode software drivers 212 cannot handle interrupts, perform DMA, or use kernel-mode resources such as non-paged memory pools.

Using the UMDF shown in FIG. 3, software drivers 212 may be designed for any protocol- or serial-bus-based device. Although these software drivers 212 run in user mode, they use the standard Plug and Play installation mechanism and the same I/O model as kernel-mode WDF software drivers.

In an alternate embodiment of the present invention, a vehicle service system is configured to report detailed operational information, such as the occurrence of faults, to a remote monitoring or diagnostic system in a secure manner, so that proprietary information is not given away, and to report detailed information without significantly affecting the work being done in the shop with a vehicle service system. Vehicle service systems having processing systems configured with a Microsoft operating system can support fault tracing concepts referred to as Windows Management Instrumentation (WMI), Windows Preprocessor (WPP) and Event Tracing for Windows (ETW).

WMI allows information about software objects to be made available to software applications responsible for managing other software objects. WMI is typically an information technology (IT) concept but has extensions to software binaries or drivers for capturing instrumentation data and events from individual device drivers and kernel components.

WPP is a layer on top of ETW, which is itself, built off of WMI. WPP and ETW are technologies used to provide information such as diagnostic data about software drivers instead of using the very old concepts of inserting “print” statements into source code to output appropriate information about the operation of a software driver at that specific point of execution. Because of the way in which WPP works, there is an increased level of security provided by a software driver implemented with WPP than in a software driver configured with embedded “print” statements, because there is no text embedded in the driver file. WPP simplifies ETW for implementation in software drivers by using macros that essentially create the ETW code. ETW and WPP designs provide several advantages, including usability from both drivers and application programs, the support of multiple processes logging concurrently, and a high throughput (on the order of 20,000 events/second) with less than 5% CPU load. ETW and WPP drivers and application programs can be easily enabled or disabled at run time without any special application awareness, and are designed to be run with production code. Additionally, ETW and WPP concepts allow for working with trace files on any machine because the tracing session and event provider (typically a software application that displays tracing output) are separate, and the logging of tracing data may be done either in a presently accessible memory or a subsequently accessible file store.

The table below gives a comparison between WPP event tracing technology and prior event tracing technologies used in the development of prior art software binares or drivers, including Performance Counter (PerfMon.exe), and embedding “print” statements at appropriate spots within the driver source code.

| Event Tracing | Performance Monitor | Print Statements |
|---|---|---|
| Discrete Events | 100 ms sampled | Random Prints |
| Accurate CPU Utilization | Aligned to system timer | Typically not time- |
| | | stamped |
| Freeform data | Data restricted by API | Freeform data |
| Detailed system info | High-level system info | No system info |

A vehicle service system, such as a vehicle wheel aligner having a processing system configured to utilize WPP in a driver, hides the text that would normally be embedded in a software driver. WPP also provides the vehicle's service system customers with the ability to help a manufacturer identify and fix encountered software or hardware problems by allowing the activation of event tracing features included with the software applications, thereby generating secure activity and event files which can then be sent to the manufacturer for subsequent analysis. The overhead cost of creating the activity and event files is very low, and does not affect normal operation of the vehicle service system.

In an alternate embodiment, a vehicle service system, such as a vehicle wheel alignment system, having a processing system is configured with a method for reporting errors and repairing software. Through a communications means, the vehicle service equipment may transmit an automatically generated report of an error that occurred during operation of the vehicle service equipment software. This report is typically transmitted to a recipient configured to analyze the data contained within the report. After a detailed examination of the report, a fix to the error may be made available so that the next time a customer connected to a communication means, the fix may be downloaded and installed on the vehicle service system.

One such method of reporting errors, fixing and installing corrections is Online Crash Analysis (OCA) which enables service equipment connected to a communications network, such as the Internet, to send a report directly to an operating system developer or software application developer in the event a software error such as a driver fault occurs on the vehicle service equipment. The information received by the developer is preliminarily analyzed and may be passed to a responsible party, such as to a vehicle service equipment manufacturer, for a detailed analysis of the error, followed by an implementation to fix the error. Once a fix has been implemented, the fix is provided to the operating system or application developer to supply to the customers, such as by making it available for download and installation at the customer's service equipment.

The quality with which a software driver is implemented is critical to the performance of that driver. A unique quality indicator that attests to a driver's quality is a desirable driver attribute. The quality indicator for a vehicle service driver 112 is included as part of the driver package 100 and can be used by the vehicle service application 121 to warn a user that a driver is or is not a quality driver. One such unique indicator for a driver on a Microsoft operating system is a catalog file. Catalog files (.cat) are signature files that are created by an operating system developer testing division, such as Microsoft Windows Hardware Quality Labs (WHQL), to certify that a driver binary file has been tested to conform to the standards of the operating system developer. If a vehicle service system manufacturer obtains a unique indicator such as a catalog file for software drivers developed in conjunction with a vehicle service system, it not only ensures that software drivers are of good quality but it also allows the vehicle service system manufacturer to create an easy-to-use, reliable installation application for the drivers using tools supplied by the operating system developer.

The present invention can be embodied in-part in the form of computer-implemented processes and apparatuses for practicing those processes. The present invention can also be embodied in-part in the form of computer program code containing instructions embodied in tangible media, such as floppy diskettes, CD-ROMs, hard drives, or an other computer readable storage medium, wherein, when the computer program code is loaded into, and executed by, an electronic device such as a computer, micro-processor or logic circuit, the device becomes an apparatus for practicing the invention.

The present invention can also be embodied in-part in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented in a general-purpose microprocessor, the computer program code segments configure the microprocessor to create specific logic circuits.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. An improved vehicle service system having a processing system, the improvement comprising:
wherein the processing system is configured with a support binary for providing support functionality to at least one vehicle service software driver, said support functionality including management of Plug-and-Play (PnP) requirements and Power Management requirements; and
wherein said support binary is independent from said supported vehicle service software driver.

2. The improved vehicle service system of claim 1 where said support binary is configured to receive I/O requests and to call said at least one vehicle service software driver to respond to said received I/O requests according to a configuration of each of said at least one vehicle service software driver.

3. The improved vehicle service system of claim 1 wherein said support binary is configured to provide intelligent defaults for handling common operations; and
wherein said at least one vehicle service software driver does not incorporate source code associated with said common operations.

4. The improved vehicle service system of claim 1 where said support binary is configured to provide support for common features required for a plurality of device classes associated with the vehicle service system.

5. The improved vehicle service system of claim 4 where said support binary is further configured to enable the addition of device-class-specific extensions to the vehicle service system.

6. The improved vehicle service system of claim 1 where said support binary is further configured with at least one Device Driver Interface (DDI) to facilitate interaction between said support binary and said vehicle service software driver.

7. The improved vehicle service system of claim 1 wherein said support binary utilizes a Microsoft Windows Driver Foundation architecture.

8. The improved vehicle service system of claim 1 wherein said support binary utilizes a Kernel-Mode Driver Framework.

9. The improved vehicle service system of claim 1 wherein said support binary utilizes a User-Mode Driver Framework.

10. An improved vehicle service system of claim 1 wherein said processing system is further configured with at least one vehicle service software application, said vehicle service software application selected from a set including a wheel alignment software application, a vehicle wheel balancing software application, a vehicle brake testing software application, and a vehicle tire changing software application.

11. The improved vehicle service system of claim 1 wherein processing system is further configured with a service software driver quality indicator.

12. The improved vehicle service system of claim 11 wherein the said quality indicator is a catalog file.

13. An improved vehicle service system having a processing system, the improvement comprising:
wherein the processing system is configured with a support binary adapted to provide support to at least one vehicle service driver; and
wherein the said support binary and said vehicle service driver are executed in a user mode process.

14. An improved vehicle service system having a processing system, the improvement comprising:
wherein the processing system is configured to support at least one software event tracing framework.

15. The improved vehicle service system of claim 14 wherein said at least one software event tracing framework is selected from a set of event tracing frameworks including at least Windows Management Instrumentation (WMI), Windows Preprocessor (WPP), and Event Tracing for Windows (ETW).

16. The improved vehicle service system of claim 14 wherein the processing system is further configured to provide information about at least one software object to a software application which is responsible for managing other software objects.

17. The improved vehicle service system of claim 14 wherein the processing system is further configured with extensions to at least one software object for capturing instrumentation data and events from device drivers and kernel components; and wherein the processing system is further configured to enable generation of an event file for remote analysis without interference with user applications.

18. An improved vehicle service system having a processing system, the improvement comprising:
wherein the processing system is configured with a method to communicate an event report to a remote system upon occurrence of a software driver fault.

19. The improved vehicle service system of claim 18 wherein said event report conforms to an Online Crash Analysis standard.

20. A method for data communication within a vehicle service system having a processing system configured with at least one vehicle service software driver and at least one hardware component, comprising:
effecting a first set of interactions between said processing system and said hardware component with a support binary component; and
effecting a second set of interactions between said processing system and said hardware component with a vehicle service software driver associated with said hardware component.
